(19) United States
(12) Patent Application Publication
(10) Pub. No.: US 2015/0322359 A1
(43) Pub. Date: Nov. 12, 2015

(54) METHOD FOR PREPARING BIODIESEL

(71) Applicants: M Energy Co., Ltd., Gyeonggi-do (KR); M Research Institute, Gyeonggi-do (KR)

(72) Inventors: Tae Ho HA, Incheon (KR); Eu Gene JEON, Gyeonggi-do (KR); Jung Hwan KO, Seoul (KR); Jun U YUN, Gyeonggi-do (KR); Seung Don LEE, Gyeonggi-do (KR); Hyeok PARK, Gyeonggi-do (KR); Jin Sik KWAK, Incheon (KR); Kang Hoon LEE, Gyeonggi-do (KR); Gyung Soo KIM, Gyeonggi-do (KR)

(21) Appl. No.: 14/377,085

(22) PCT Filed: Jan. 29, 2014
(86) PCT No.: PCT/KR2014/000886

§ 371 Date: Aug. 6, 2014

(30) Foreign Application Priority Data
Mar. 20, 2013 (KR) 10-2013-0029572

(51) Int. Cl. C10L 1/02; C11B 3/06; C11B 3/00

(52) U.S. Cl. CPC C10L 1/026; C11B 3/003; C11B 3/06; C10L 2270/026; C10L 2200/0476; C10L 2290/26; C10L 2290/08; C10L 2290/542

(57) ABSTRACT

Disclosed herein is a method of preparing biodiesel, including the steps of: removing foreign materials from biodiesel raw oil containing lower fatty acid and having an acid value of 20 mgKOH/g or less with an adsorbent; dewatering the foreign materials removed biodiesel raw oil; passing the dewatered biodiesel raw oil through a solid acid catalyst reaction guard bed provided with a cation exchange resin for removing metal cations at 20˜80° C. at a flow rate of 6 vol % (6 SV) or less, mixing methanol with the passed biodiesel raw oil, and then passing the mixture through a solid acid catalyst reaction main bed provided with a solid acid catalyst for an esterification reaction at 70˜120° C. at a flow rate of 0.5˜1.5 SV to adjust a final acid value of the biodiesel raw oil to 5 mgKOH/g or less; and reacting the biodiesel raw oil having the final acid value of 5 mgKOH/g or less in the presence of an alkali catalyst.

### TECHNICAL FIELD

The present invention relates to a method of preparing biodiesel.

### BACKGROUND ART

With the development of industries, the use of industrial machines including a diesel engine has increased, and automobiles have become essential to modern life, and simultaneously the production of automobiles has increased all over the world, and thus the consumption of diesel oil used as a raw material for diesel engine automobiles has increased. Diesel oil is one of the fuels obtained from crude oil, and is advantageous in that it has high fuel efficiency, is low in price, and reduces the generation of carbon dioxide (CO₂). However, diesel oil is problematic in that it emits a large amount of air pollutants after combustion compared to other fuels obtained from crude oil.

In order to solve the above problem, much research has been conducted to find alternative fuels which have similar physical properties to diesel oil, are economical in terms of production, and can prevent air pollution. As a result of such research, much focus has been given to biodiesel which is a natural circulation energy source and which has similar physical properties to diesel oil, can remarkably reduce the emission of air pollutants and can exhibit the effect of reduction of carbon dioxide (CO₂).

Therefore, many countries are actively increasing the production and use of biodiesel as an alternate reproducible energy source due to the exhaustion of petroleum energy resources and to reduce the generation of carbon dioxide attributable to the excessive use of fossil fuel.

Biodiesel is referred to as ester oil prepared by reacting various reproducible resources such as various plant oils including rapeseed oil, soybean oil, palm oil and the like, animal oils including beef tallow and the like, and waste cooking oils, etc. with alcohol in the presence of a catalyst. Since biodiesel has similar physical properties to diesel oil, it can be used for compression-ignition type diesel engines instead of diesel oil or in combination with diesel oil. That is, biodiesel may be defined as an alternative fuel to diesel oil, which is prepared by the chemical reaction of animal or plant fatty acid with methanol.

As such, biodiesel is made by reacting aliphatic alcohol such as methanol with animal or plant oil, and, in this case, the yield and quality of biodiesel are determined depending on the properties of animal or plant oil used as a raw material for biodiesel. The biodiesel produced using unpurified animal or plant oil as a raw material has many problems such as yield reduction during the synthesis process, quality deterioration and the like.

In order to solve the problem of yield and quality, a large majority of biodiesel makers have used purified edible soybean oil, rapeseed oil or the like as a raw material for biodiesel. However, the method of using food resources as energy resources causes many problems without regard to the original purpose of alternative energy, and is not suitable in terms of economical efficiency because edible soybean oil or rapeseed oil is expensive.

All over the world, currently, plenty of animal and plant oils and fats converted into by-products or after usage are mostly used as raw material for feeds or soaps. Some animal and plant fats and oils, including 2.0% or less of free fatty acid (FFA) among impurities, are used as raw materials for biodiesel after a simple separation and chemical refining treatment.

Meanwhile, biodiesel raw oils containing lower fatty acids having an acid value of 5 mgKOH/g or more, for example, lower waste cooking oil, palm acid oil obtained by the alkali-refining of palm oil, brown grease obtained from food waste, dark oil obtained from alkali oil ash (soap stock), white grease and yellow grease obtained by the primary refining of dark oil, trap grease obtained from ditches, drains or the like, and animal and plant oils and fats containing a large amount of non-purified impurities, include a large amount of particulate matter, gums, fatty acids, soaps, moisture and the like, and cause the deterioration of yield and quality of biodiesel in the process of preparing biodiesel by the fatty acid methyl esterification.

In other words, particulate matter included in waste cooking oil or animal and plant oils and fats containing a large amount of non-purified impurities causes problems of being an obstacle to a biodiesel preparing apparatus, decreasing the yield of biodiesel, contaminating a distillation process and deteriorating the quality of glycerin of a by-product.

Particularly, WA (free fatty acid) reacts with an alkali catalyst in the synthesis of biodiesel to form soap and cause the loss of the alkali catalyst. In this case, biodiesel and glycerin are emulsified due to the formed soap, and thus it is difficult to separate biodiesel and glycerin from each other, thereby decreasing the yield of biodiesel and deteriorating the quality of biodiesel. Further, due to water formed during the reaction, biodiesel is hydrolyzed by the water to form FFA (free fatty acid), DAG (di-acyl glyceride) and MAG (mono-acyl glyceride).

That is, the soap contained in a biodiesel raw oil or the soap component formed in the procedure of synthesis of biodiesel is emulsified with an oil fraction, so it is difficult to separate them from each other, with the result that the yield of biodiesel decreases, the quality of biodiesel deteriorates, the quality of glycerin as a by-product also deteriorates, and the post-treatment process of by-products becomes complicated.

Meanwhile, Patent document 1 discloses a method of making a biodiesel raw oil by refining animal and plant oils and fats containing a large amount of impurities; Patent document 2 discloses a method of removing free fatty acid contained in waste cooking oil using a heterogeneous solid acid catalyst; and Patent document 3 discloses a method of preparing biodiesel, wherein water included in alcohol recovered from a process of preparing biodiesel from oil and fat containing free fatty acid is removed by pervaporation, and is then resupplied into a reactor, so the action of water on esterification and trans-esterification reactions is reduced, thereby increasing the purity and yield of biodiesel.

In the above-mentioned methods, biodiesel is prepared using a generally-known alkali catalyst, alkoxide catalyst, solid acid catalyst, metal catalyst or the like through a continuous or batch process. However, currently, such processes are problematic in that various kind, and low-quality biodiesel raw oils cannot be efficiently treated.

Patent document 1: Korean Patent Registration No. 10-0950280

Patent document 2: Koran Patent Application Publication No. 2004-0087625

Patent document 3: Koran Patent Application Publication No. 2009-0129619

### DISCLOSURE OF INVENTION

### Technical Problem

Thus, the present inventors found that when a biodiesel raw oil is selectively pretreated according to the physical properties thereof to control the acid value of the biodiesel raw oil to a predetermined value or less, and then a combination of a biological catalyst process, a solid acid catalyst process and an alkali metal catalyst process is carried out, so the reactivity of a catalyst is efficiently increased, high-grade biodiesel, such as fuel for automobiles, can be economically prepared. Based on this finding, the present invention was completed.

Accordingly, an object of the present invention is to provide a method of economically and efficiently preparing biodiesel using a combination of a biological catalyst process, a solid acid catalyst process and an alkali metal catalyst process.

Another object of the present invention is to provide a method of economically and efficiently preparing biodiesel using a combination of an enzyme catalyst process, a solid acid catalyst process and an alkali metal catalyst process.

### Solution to Problem

In order to accomplish the above objects, a first aspect of the present invention provides a method of preparing biodiesel, including the steps of: treating biodiesel raw oil containing lower fatty acid and having an acid value of 20 mgKOH/g or less with an adsorbent to remove foreign materials from the biodiesel raw oil; dewatering the purified biodiesel raw oil; passing the dewatered biodiesel raw oil through a solid acid catalyst reaction guard bed (Guard bed: PBR) provided with a cation exchange resin for removing metal cations, mixing methanol with the passed biodiesel raw oil, and then passing the mixture through a solid acid catalyst reaction main bed (Main Bed: PFR) provided with a solid acid catalyst for an esterification reaction to adjust the final acid value of the biodiesel raw oil to 5 mgKOH/g or less; and reacting the biodiesel raw oil having a final acid value of 5 mgKOH/g or less in the presence of an alkali catalyst.

A second aspect of the present invention provides a method of preparing biodiesel, including the steps of: treating biodiesel raw oil containing lower fatty acid and having an acid value of more than 20 mgKOH/g with an adsorbent to remove foreign materials from the biodiesel raw oil; passing the purified biodiesel raw oil through a continuous stiffed tank reactor (CSTR) provided with an enzyme catalyst for an esterification reaction and a trans-esterification reaction in the presence of methanol, water and a buffer solution to adjust the acid value of the biodiesel raw oil to 20 mgKOH/g or less and adjust the content of FAME to 60% or less, and then separating glycerin; dewatering the biodiesel raw oil; passing the dewatered biodiesel raw oil through a solid acid catalyst reaction guard bed provided with a cation exchange resin for removing cations, mixing methanol with the biodiesel raw oil passed through the solid acid catalyst reaction guard bed, and then passing the mixture through a solid acid catalyst reaction main bed provided with a solid acid catalyst for an esterification reaction to adjust the final acid value of the biodiesel raw oil to 5 mgKOH/g or less; and reacting the biodiesel raw oil having a final acid value of 5 mgKOH/g or less in the presence of an alkali catalyst.

In the first or second aspect, the biodiesel raw oil having lower fatty acid may be at least one selected from the group consisting of waste lower cooking oil, palm acid oil, brown grease, white grease, yellow grease, dark oil, trap grease, and non-purified animal oils and fats.

In the first or second aspect, the step of removing foreign materials may be performed by adding 0.1˜5 wt % of an adsorbent at a reaction temperature of 30˜150° C. and a reaction time of 15 minutes˜3 hours.

In the first or second aspect, the adsorbent may be at least one selected from the group consisting of diatomite, acidic white clay, active white clay, activated carbon and magnesium silicate.

In the second aspect, the buffer solution not causing saponification may be at least one selected from the group consisting of a sodium bicarbonate solution, a sodium carbonate solution, a sodium phosphate solution, a 3-(N-morpholine)propanesulfonic acid solution, a (2-(N-morpholine)ethanesulfonic acid solution, a piperazine-N,N′-bis(2-ethanesulfonic acid) solution, and a (N-(2-hydroxyethyl)piperazine(2-ethanesulfonic acid) solution, and the buffer solution is added until the pH of the biodiesel raw oil is present in a range of 6˜7.9.

In the first or second aspect, in the step of dewatering the biodiesel raw oil, water may be removed until the content of water is 0.1 wt % or less.

In the second aspect, before the step of dewatering the biodiesel raw oil, biodiesel raw oil for an enzyme catalyst reaction may be mixed with biodiesel raw oil containing no foreign materials and having an acid value of 20 mgKOH/g or less at a weight ratio of 1:1 or more to adjust the content of FAME to 40% or less.

In the second aspect, the enzyme catalyst reaction may be performed at a reaction temperature of 20˜40° C. using 20˜60 parts by weight of a catalyst, 1˜20 parts by weight of alcohol, 1˜10 parts by weight of water, based on 100 parts by weight of the biodiesel raw oil, and a buffer solution capable of adjusting the pH of the biodiesel raw oil to 6˜7.9.

In the first or second aspect, the temperature condition may be 20˜80° C., and pass rate may be 6 vol % (6 SV) or less in the solid acid catalyst reaction guard bed.

In the first or second aspect, the temperature condition may be 70˜120° C., and a flow rate may be 0.5˜1.5 SV in the solid acid catalyst reaction main bed.

In the first or second aspect, the alkali catalyst may be at least one selected from the group consisting of sodium methoxide (NaOCH₃), sodium hydroxide (NaOH), potassium methoxide (KOCH₃), and potassium hydroxide (KOH).

In the first or second aspect, the step of reacting the biodiesel raw oil in the presence of an alkali catalyst may be performed at a reaction temperature of 50˜80° C. and a reaction time of 10 minutes-2 hours.

### Advantageous Effects of Invention

The advantageous effects of the present invention are as follows.

1. Impurities are removed from a biodiesel raw oil containing a large amount of nonpurified impurities by the pre-treatment of the biodiesel raw oil, thus solving the problems of obstructing the operation of a biodiesel preparing apparatus, decreasing the yield of biodiesel and making the separation of biodiesel and glycerin difficult after the synthesis of biodiesel.

2. The selectivity of biodiesel raw materials becomes wide because the limitations in the kind of raw materials and the content of FFA (free fatty acid) disappear according to the usage of an enzyme catalyst and a solid acid catalyst.

3. Since methanol used in an enzyme catalyst reaction is not greatly influenced by the content of water, the methanol recovered after being used in the reaction can be reused without performing a dewatering process, so additional equipment is not needed, and a process cost can be reduced.

4. A general alkali catalyst process becomes complicated because it needs a deacidification process when a raw material containing a large amount of fatty acid. However, since the present invention is not influenced by the content of fatty acid, a process can be simplified, and the yield of biodiesel can be improved by converting FFA into biodiesel, not by removing FFA from a raw material.

5. Since glycerin, which is a by-product obtained from a general alkali catalyst process, contains metal salts, its quality is lowered, and thus a complicated refining process for obtaining high-purity glycerin is necessarily required. However, since glycerin obtained in the present invention does not contain metal salts, a refining process can be simplified.

### BRIEF DESCRIPTION OF DRAWINGS

The above and other objects, features and other advantages of the present invention will be more clearly understood from the following detailed description taken in conjunction with the accompanying drawings, in which:

FIG. 1 is a schematic diagram showing a solid acid catalyst reactor including a guard bed and a main bed according to the present invention; and

FIG. 2 is a flow diagram showing a process of preparing biodiesel according to the present invention.

### REFERENCE NUMERALS

10: RAW OIL
20: GUARD BED
30: MIX TANK
40: PUMP
50: MAIN BED
60: PRESSURE CONTROL VALVE
70: CONDENSER

### BEST MODE FOR CARRYING OUT THE INVENTION

Prior to the detailed description of the present invention, the terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe the best method he or she knows for carrying out the invention.

Hereinafter, preferred embodiments of the present invention will be described in detail with reference to the attached drawings such that those skilled in the art can easily carry out the present invention. Further, in the description of the present invention, when it is determined that the detailed description of the related art would obscure the gist of the present invention, the description thereof will be omitted.

Generally, biodiesel is prepared by reacting animal and plant oil and fat with aliphatic alcohol in the presence of an alkali catalyst to esterify the reactants. Among various biodiesel preparation methods, a method of preparing biodiesel using an alkali catalyst is most frequently used. Currently, as the alkali catalyst, sodium methoxide (NaOCH₃) is generally used, and sodium hydroxide (NaOH), potassium methoxide (KOCH₃), potassium hydroxide (KOH) or the like is used, too. The reason why relatively expensive sodium methoxide is generally used is that biodiesel can be obtained in a high yield even when a raw material contains water.

In addition to the above typical biodiesel preparation method, there are several biodiesel preparation methods. For example, there are, first, a method of preparing biodiesel by reacting animal and plant oil and fat with aliphatic alcohol at high temperature and high pressure in the presence of an acid catalyst such as sulfuric acid; second, a method of preparing biodiesel by hydrolyzing animal and plant oil and fat into fatty acid and then reacting the fatty acid with aliphatic alcohol in the presence of an acid catalyst; third, a method of preparing biodiesel by reacting animal and plant oil and fat with aliphatic alcohol using an insoluble catalyst such as barium oxide; and, fourth, a method of preparing biodiesel by reacting animal and plant oil and fat with aliphatic alcohol using an enzyme catalyst such as lipase, and the like.

The present invention provides a method of economically and efficiently preparing biodiesel from biodiesel raw oil containing lower fatty acid and having an acid value of 5 mgKOH/g or more and a maximum acid value of 200 mgKOH/g.

First, according to an aspect of the present invention, there is provided a method of economically and efficiently preparing biodiesel from biodiesel raw oil containing lower fatty acid and having an acid value of 5 mgKOH/g or more and a maximum acid value of 200 mgKOH/g using a combination of a solid acid catalyst and an alkali metal catalyst.

Further, according to another aspect of the present invention, there is provided a method of economically and efficiently preparing biodiesel from biodiesel raw oil containing lower fatty acid and having an acid value of more than 20 mgKOH/g using a combination of an enzyme catalyst, a solid acid catalyst and an alkali metal catalyst.

1. Pretreatment of Raw Oil

According to the present invention, an adsorbent is added to biodiesel raw oil containing lower fatty acid and having an acid value of 5 mgKOH/g or more and a maximum acid value of 200 mgKOH/g to remove a large amount of foreign materials, such as particulate matter, gums, soaps, moisture and the like, from the biodiesel raw oil.

In the present invention, the biodiesel raw oil (hereinafter, referred to as “raw oil”) having lower fatty acid may be at least one selected form the group consisting of lower waste cooking oil, palm acid oil, brown grease, white grease, yellow grease, dark oil, trap grease, and non-purified animal oils and fats. However, the raw oil is not limited thereto, and all raw oils may be used as long as they can be used as the raw material of biodiesel.

Lower fatty acids, such as brown grease and the like, contain various sizes of foreign materials according to the generation source thereof, and produce bad odors. Therefore, various kinds of filter aids may be used, but, in the present invention, an adsorbent is preferably used because it has excellent adsorptivity, deodorization ability and humidity control performance to exhibit the effects of adsorbing foreign materials, removing bad smells and reducing humidity in the lower fatty acid. Examples of the adsorbent exhibiting such effects may include diatomite, white clay (acidic white clay, active white clay, etc.), activated carbon and/or magnesium (magnesium silicate). Diatomite is preferred as adsorbent. The amount of the adsorbent may be 0.1˜5 wt %. When the amount thereof is less than 0.1 wt %, the addition effect thereof is insufficient, and, when the amount thereof is more than 5 wt %, the adsorbent is apt to absorb the raw oil, which is not preferred.

The adsorption reaction is performed at a temperature of 30˜150° C., preferably, 50˜80° C. The lower raw oil, such as brown grease, lower waste cooking oil, palm acid oil, yellow grease, dark oil or the like, may include a large amount of saturated fatty acid according to the source thereof. In the pre-treatment process using such raw oil, the fluidity of the raw oil is lowered at room temperature. Therefore, in order to guarantee the fluidity thereof, the raw oil is heated (the heating temperature of the raw oil is changed depending on the content of saturated fatty acid in the raw oil), thus sufficiently and effectively reacting the raw oil with the adsorbent.

The adsorption reaction in the pre-treatment process may be performed at a reaction temperature of 30˜150° C. and a reaction time of 15 minutes˜3 hours. The ability of the adsorbent to adsorb foreign materials is best when the adsorption reaction is performed at a reaction temperature of 50˜80° C. and a reaction time of 30 minutes ˜1.5 hours. When the adsorption reaction is completed, the raw oil mixed with the adsorbent is filtered by a filter press, a leaf filter or a centrifugal separator. After the filtering, it is preferred that the filtered raw oil contain particles of 1 μm or less in an amount of 1 wt % or less. Hereinafter, this filtered raw oil is referred to as “pretreated raw oil” or “pretreatment-finished raw oil”.

2. Reaction of Raw Oil According to Acid Value

1) Solid Acid Catalyst Reaction

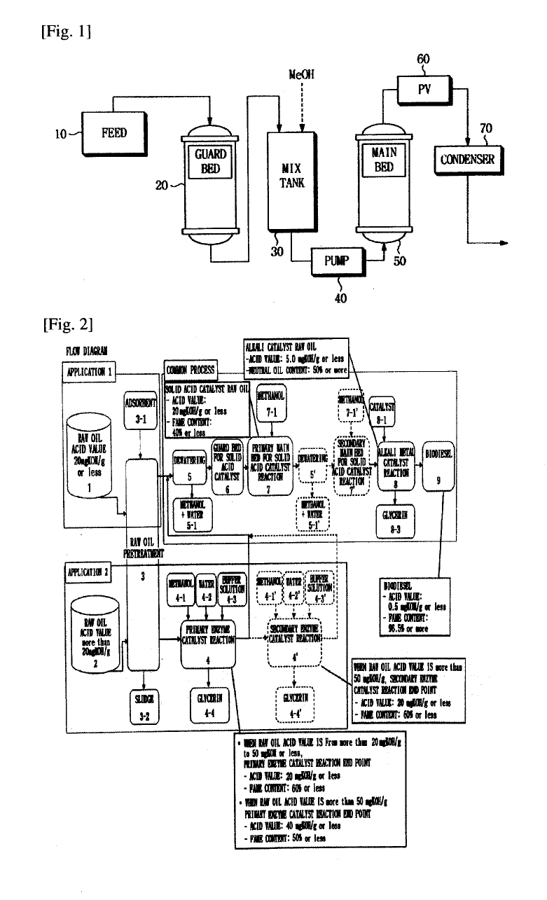

Referring to FIG. 1, raw oil 10 having an acid value of 20 mgKOH/g or less is pretreated as above, and then the pretreated raw oil is dewatered to remove water until the content of water is 0.1 wt % or less. Subsequently, the dewatered raw oil is passed through a solid acid catalyst reaction guard bed 20 (PBR: packed bed reactor) provided with a cation exchange resin for removing cations, mixed with methanol in a mix tank 30, and then supplied to a solid acid catalyst reaction main bed 50 (PFR: plug flow reactor) provided with a solid acid catalyst for an esterification reaction by a pump 40 to perform a solid acid catalyst reaction. This reaction product is condensed by a condenser 70, and then transferred to a subsequent process.

Meanwhile, when the acid value of the raw oil is 5 mgKOH/g or less, preferably, 2 mgKOH/g or less, the reaction is finished. When the acid value of the raw oil is more than 5 mgKOH/g, methanol is recovered, and the raw oil is further passed through the solid acid catalyst reaction main bed to adjust the final acid value of the biodiesel raw oil to 5 mgKOH/g or less, preferably, 2 mgKOH/g or less, which is suitable for maximizing the efficiency of the following alkali catalyst process.

In the present invention, the reason for removing water in the raw oil is that water is produced with the occurrence of the solid acid catalyst reaction using a solid acid catalyst for an esterification reaction, and the produced water causes a reverse reaction, and thus the acid value of the raw oil exceeds the target acid value 5 mgKOH/g. Further, the reason for removing metal cations from the raw oil is that the metal cations cause a substitution reaction together with hydrogen ion (H⁺) to deteriorate the activity of the solid acid catalyst, thus reducing the life time of the solid acid catalyst. Moreover, the reason for using raw oil having an acid value of 20 mgKOH/g or less is that it is difficult to attain the target acid value 5 mgKOH/g of the raw oil (product).

2) Enzyme Catalyst Reaction and Solid Acid Catalyst Reaction

The raw oil having an acid value of more than 20 mgKOH/g is pretreated, and is then sequentially supplied to first and second continuous stirred tank reactors (CSTRs), each being provided with an enzyme catalyst for an esterification reaction and a transesterification reaction, to perform an enzyme catalyst reaction until the acid value of the enzyme catalyst reaction product (raw oil) is 20 mgKOH/g or less. In this enzyme catalyst reaction, glycerin is produced, and this glycerin is separated by gravity separation or centrifugal separation.

Raw oil for an enzyme catalyst reaction is mixed with raw oil containing no foreign materials and having an acid value of 20 mgKOH/g or less at a weight ratio of 1:1 or 1:2 or more (for example, 1:2, 1:3, etc.). Then, the mixed raw oil is dewatered to remove water and methanol, and is then sequentially supplied to a solid acid catalyst reaction guard bed (PBR) provided with a cation exchange resin for removing cations and a solid acid catalyst reaction main bed (PBR) provided with a solid acid catalyst for an esterification reaction to perform a solid acid catalyst reaction.

In this case, the reason for mixing the raw oil for an enzyme catalyst reaction with the raw oil containing no foreign materials and having an acid value of 20 mgKOH/g or less at a weight ratio of 1:1 or 1:2 or more is that, when the content of fatty acid methyl ether (FAME) in the raw oil, the solid acid catalyst for an esterification reaction causes a reverse reaction due to the water produced during the solid acid catalyst reaction, and thus the acid value of the raw oil (product) exceeds the target acid value 5 mgKOH/g.

In the method of preparing biodiesel according to the present invention, the pretreated raw oil is mixed with methanol, water and a buffer solution, and then the mixture is reacted in a continuous stirred tank reactor (CSTR) provided with an enzyme catalyst for an esterification reaction and a trans-esterification reaction.

Meanwhile, the buffer solution, which is a solution changing the pH of reactants to the neutral position by neutralizing the reactants while not participating in a reaction, must not cause saponification. According to the present invention, all buffer solutions having a pKa of 9 or more may be used without limitation as long as they do not create by-products such as soap and the like while adjusting pH.

Examples of the buffer solution not causing saponification may include: a sodium bicarbonate solution; a sodium carbonate solution; a sodium phosphate solution such as Na₂HPO₄.2H₂O or NaH₂PO₄.2H₂O; a 3-(N-morpholine)propanesulfonic acid solution; and a ethanesulfonic acid solution such as a (2-(N-morpholine)ethanesulfonic acid solution, a piperazine-N,N′-bis(2-ethanesulfonic acid) solution or a (N-(2-hydroxyethyl)piperazine(2-ethanesulfonic acid) solution.

The buffer solution is added until the pH of the raw oil is present in a range of 6˜7.9, and the raw oil having the above range of pH can maximize the activity of an enzyme catalyst in the process of preparing biodiesel. As above, the buffer solution can adjust the pH of the raw oil, and must not cause saponification. When a general pH adjuster is added to the raw oil, saponification is caused, so a subsequent process of removing soap is required, and the yield of biodiesel is remarkably lowered.

3) Enzyme Catalyst and Enzyme Catalyst Reaction Condition

As the enzyme catalyst used in the present invention, 40 or more kinds of lipases and phospholipases can be commercially used, but, it is preferred that a circular plastic carrier having an outer diameter of 2˜3 mm be supported with this enzyme catalyst.

Meanwhile, the biodiesel raw oils applicable to the present invention, for example, purified raw oils such as soybean oil, rapeseed oil, palm oil and the like can be used without pretreatment. However, in the present invention, biodiesel can be prepared using one or two or more mixture selected from the group consisting of palm acid oil, waste cooking oil, brown grease, dark oil, white grease, yellow grease, tap grease and non-purified animal and plant oils and fats. Further, biodiesel may also be prepared using a raw oil containing fatty acid generated from crude glycerin produced in the biodiesel preparation process. Generally, the biodiesel raw oil may be used without limitation as long as it has a pH of 6˜8 and contains particles having a diameter of 1 μm or less in an amount of 1 wt % or less.

The raw oil is sequentially supplied to first and second continuous stirred tank reactors (CSTRs) provided with an enzyme catalyst for an esterification reaction and a trans-esterification reaction in the presence of alcohol, water and/or a buffer solution according to the measured acid value of the raw oil.

The enzyme catalyst for an esterification reaction and a trans-esterification reaction is a catalyst synthesizing fatty acid methyl ester (FAME) by an esterification reaction of FFA or a trans-esterification reaction of mono-glyceride, di-glyceride or tri-glyceride.

Generally, the enzyme catalyst reaction is performed at 20˜40° C. The enzyme catalyst is used in an amount of 20˜60 parts by weight, alcohol is used in an amount of 1˜20 parts by weight, and water is used in an amount of 1˜10 parts by weight, based on 100 parts by weight of the biodiesel raw oil. The buffer solution is added such that the pH of the raw oil is 6˜7.9.

4) Solid Acid Catalyst Reaction Condition

Prior to the solid acid catalyst esterification reaction, the content of water in the raw oil (feed) may be controlled to be 0.1 wt % or less. The pretreated dewatered raw oil and the dewatered product of the enzyme product may pass through solid acid catalyst reaction guard bed (cation exchange resin) in a down-flow manner to remove metal cations. In this case, this process is performed at 20˜80° C., and they are passed through the guard bed at a flow rate of 6 vol % (6 SV) or less. These conditions are advantageous in terms of economical profit and reaction efficiency.

In a solid acid catalyst reaction main bed, the pretreated (foreign matter-removed, dewatered and cation-removed) raw oil is mixed with methanol (10˜50 wt %, based on raw oil), or methanol of enzyme catalyst reaction product, and then the mixture is sequentially passed through first and second packed bed reactors (PBRs) provided with a solid acid catalyst for an esterification reaction to conduct a solid catalyst reaction in an up-flow manner (reaction temperature: 70˜120° C., reaction flow rate: 0.5˜1.5 SV, reactor in-out p: 2.0 kgf/cm² or less).

3. Alkali Catalyst Reaction

Among biodiesel preparation methods, an alkali catalyst method is generally used.

Here, as an alkali catalyst, sodium methoxide (NaOCH3), sodium hydroxide (NaOH), potassium methoxide (KOCH3), and/or potassium hydroxide (KOH) may be used. In the present invention, when the acid value of the product in the previous process is 2 to 5 mgKOH/g and the water content thereof is less than 0.5 wt %, a potassium hydroxide catalyst is used; when the acid value thereof is 2 mgKOH/g or less and the water content thereof is less than 0.5 wt %, a sodium hydroxide catalyst is used; when the acid value thereof is 2 to 5 mgKOH/g and the water content thereof is 0.5 to 1 wt %, a potassium methoxide catalyst is used; and when the acid value thereof is 2 mgKOH/g or less and the water content thereof is 0.5 to 1 wt %, a sodium methoxide catalyst is used. In this case, when the acid value of raw oil is 5.0 mgKOH/g or more, the yield of biodiesel is rapidly reduced after an alkali metal catalyst reaction, thus decreasing economical efficiency, and the acid value thereof does not meet the quality standard (5.0 mgKOH/g or less) of an automobile fuel, and thus it is preferred that raw oil having an acid value of 5.0 mgKOH/g or less be used.

Biodiesel and glycerin are produced by reacting the product obtained from the solid acid catalyst process at a reaction temperature of 50˜80° C. for 10 minutes-2 hours using the above solid acid catalyst according to the acid value and water content thereof. The glycerin is separated by gravimetric separation or centrifugal separation. Meanwhile, if necessary, the alkali catalyst process may be performed by mixing a new high-grade raw oil having an acid value of 5 mgKOH/g or less with the product obtained from the solid acid catalyst process. In this case, the alkali catalyst reaction may be performed by adding insufficient methanol. Meanwhile, the above conductions are preferred in terms of economical profit and reaction efficiency.

### MODE FOR THE INVENTION

Hereinafter, the present invention will be described in more detail with reference to the following Examples and Comparative Example. However, the scope of the present invention is not limited to these Examples.

### Example 1

20 g of diatomite was added to 1000 g of brown grease (BG) having an acid value of about 19.9 mgKOH/g and a water content of 0.5%, and then reacted at about 70° C. for about 1 hour. The reaction conditions and results thereof are given in Table 1 below.

TABLE 1

| | Pretreatment | Pretreatment |
|---|---|---|
| Class. | input (g) | product (g) |
| BG | 1,000 | 991.14 |
| Diatomite | 20 | |
| Filtered waste | | 29 |
| Sum | 1,020 | 1,020 |

| | |
|---|---|
| Reduction rate | 0.89% |
| Water (%) | 0.10 |
| Acid value (mgKOH/g) | 19.9 |

### Comparative Example 1

70 g of diatomite was added to 1000 g of brown grease (BG) having an acid value of about 19.9 mgKOH/g and a water content of 0.5%, and then reacted at about 70° C. for about 1 hour. The reaction conditions and results thereof are given in Table 2 below.

TABLE 2

| | Pretreatment | Pretreatment |
|---|---|---|
| Class. | input (g) | product (g) |
| BG | 1,000 | 946.22 |
| Diatomite | 70 | |
| Filtered waste | | 124 |
| Sum | 1,070 | 1,070 |

| | |
|---|---|
| Reduction rate | 5.38% |
| Water (%) | 0.07 |
| Acid value (mgKOH/g) | 19.9 |

As given in Tables 1 and 2, it can be ascertained that, when diatomite was used in a suitable amount, the yield of biodiesel in Example 1 was 99.11% without changing the acid value of brown grease, which was increased by 4.49% compared to the yield of biodiesel in Comparative Example 1.

### Example 2

20 g of diatomite was added to 1000 g of raw oil (FFA: about 10%, tri-glyceride: about 90%) having an acid value of about 19.8 mgKOH/g, and then reacted at about 70° C. for about 1 hour to obtain biodiesel raw oil. The obtained biodiesel raw oil includes about 0.6 wt % of particles having a diameter of 1 μm or less.

The biodiesel raw oil was reacted according to the reaction order shown in the application 1 of FIG. 2 under the reaction condition given in Table 3 below. A solid acid catalyst of guard bed for removing cations may be provided with a cation exchange resin of K2629™ (manufactured by LANXESS Corporation in Germany). A solid acid catalyst of main bed for an esterification reaction may be provided with GF-101™ (manufactured by LANXESS Corporation in Germany) of polymer resin supported SO₃H⁺.

In this Example, the raw oil having passed through the solid acid catalyst guard bed was mixed with methanol, and the mixture was reacted in the solid acid catalyst main bed, thus obtaining raw oil having an acid value of 1.94 mgKOH/g.

TABLE 3

| | Raw oil (acid value: 19.8 mgKOH/g) | | |
|---|---|---|---|
| | | Solid acid | Solid acid |
| | | catalyst | catalyst |
| Class. | | guard bed | main bed |

| | | | | |
|---|---|---|---|---|
| Reaction | about 30° | C. | about 80° | C. |
| temperature | | | | |
| Raw oil | 100 | parts | 100 | parts |
| Catalyst | 50 | parts | 50 | parts |

| | | | |
|---|---|---|---|
| Methanol | — | 50 | parts |

| | | | | |
|---|---|---|---|---|
| Reaction rate | 2 | SV | 3 | SV |

| | | |
|---|---|---|
| Reaction | — | acid value: |
| end point | | 2.0 mgKOH/g |
| | | or less |

### Example 3

20 g of diatomite was added to 1000 g of raw oil having an acid value of about 49.4 mgKOH/g (FFA: about 24.7%, tri-glyceride: about 75.3%), and then reacted at about 70° C. for about 1 hour to obtain biodiesel raw oil. The obtained biodiesel raw oil includes about 0.5 wt % of particles having a diameter of 1 tan or less.

The biodiesel raw oil was reacted according to the reaction order shown in the application 2 of FIG. 2 under the reaction condition given in Table 4 below. A CSTR was provided with an enzyme catalyst (TRANSZYME™ manufactured by TRASBIODIESEL Corporation in Israel) in which lipase is supported with plastic. A solid acid catalyst guard bed for removing cations was provided with a cation exchange resin (K2629™ manufactured by LANXESS Corporation in Germany). A solid acid catalyst main bed for an esterification reaction was provided with a polymer resin (GF-101™ manufactured by LANXESS Corporation in Germany) supported with SO₃H⁺.

In this Example, about 15 parts by weight of glycerin, which is a by-product of an enzyme catalyst reaction in CSTR, water and the like were removed from the pretreated raw oil. This raw oil was mixed with the pretreated raw oil having an acid value of 20 mgKOH/g or less at a ratio of 1:1 (wt %), dewatered, and then supplied to a solid acid catalyst guard bed. The raw oil having passed through the solid acid catalyst guard bed was mixed with methanol, and the mixture was reacted in the solid acid catalyst main bed, thus obtaining raw oil having an acid value of 1.91 mgKOH/g.

TABLE 4

| | Raw oil (acid value: 49.4 mgKOH/g) | | | | | |
|---|---|---|---|---|---|---|
| | Enzyme | | Solid acid | | Solid acid | |
| | catalyst | | catalyst | | catalyst | |
| Class. | CSTR | | guard bed | | main bed | |
| Reaction | 30° | C. | about 30° | C. | about 80° | C. |
| temperature | | | | | | |
| Raw oil | 100 | parts | 100 | parts | 100 | parts |
| Catalyst | 50 | parts | 50 | parts | 50 | parts |

| | | | | | |
|---|---|---|---|---|---|
| Methanol | 10 | parts | — | 50 | parts |

| | | | | |
|---|---|---|---|---|
| water | 3 | parts | — | — |
| 1N SBC | 2 | parts | — | — |

| | | | |
|---|---|---|---|
| Reaction | acid value: | — | acid value: |
| end point | 20.0 mgKOH/g | | 2.0 mgKOH/g |
| | or less | | or less |
| | FAME content: | | FAME content: |
| | 60.0% or less | | 40.0% or less |

### Example 4

20 g of diatomite was added to 1000 g of raw oil (FFA: about 49.75%, tri-glyceride: about 50.25%) having an acid value of about 99.5 mgKOH/g, and then reacted at about 70° C. for about 1 hour to obtain biodiesel raw oil. The obtained biodiesel raw oil includes about 0.4 wt % of particles having a diameter of 1 μm or less.

The biodiesel raw oil was reacted according to the reaction order shown in the application 2 of FIG. 2 under the reaction condition given in Table 5 below. A CSTR was provided with an enzyme catalyst (TRANSZYME™ manufactured by TRASBIODIESEL Corporation in Israel) in which plastic is supported with lipase, A solid acid catalyst guard bed for removing cations was provided with a cation exchange resin (K2629™ manufactured by LANXESS Corporation in Germany), and A solid acid catalyst main bed for an esterification reaction was provided with a polymer resin (GF-101™ manufactured by LANXESS Corporation in Germany) supported with SO₃H⁺.

In this Example, about 15 parts by weight of glycerin, which is a by-product of an enzyme catalyst reaction in CSTR 1, water and the like were removed from the pretreated raw oil, and then this raw oil was supplied to CSTR 2. Then, about 15 parts by weight of glycerin, which is a by-product of an enzyme catalyst reaction in CSTR 2, water and the like were removed from the pretreated raw oil. This raw oil was mixed with the pretreated raw oil having an acid value of 20 mgKOH/g or less at a ratio of 1:1 (wt %), dewatered, and then supplied to a solid acid catalyst guard bed 1. The raw oil having passed through the solid acid catalyst guard bed 1 was mixed with methanol, and the mixture was reacted in the solid acid catalyst main guard 1, thus obtaining raw oil having an acid value of 1.73 mgKOH/g.

TABLE 5

| | Raw oil (acid value: 99.5 mgKOH/g) | | | | | | | |
|---|---|---|---|---|---|---|---|---|
| | Enzyme | | Enzyme | | Solid acid | | Solid acid | |
| | catalyst | | catalyst | | catalyst | | catalyst | |
| Class. | CSTR 1 | | CSTR 2 | | guard bed | | main bed 1 | |
| Reaction | 30° | C. | 30° | C. | about 30° | C. | about 80° | C. |
| temperature | | | | | | | | |
| Raw oil | 100 | parts | 100 | parts | 100 | parts | 100 | parts |
| Catalyst | 50 | parts | 50 | parts | 50 | parts | 50 | parts |

| | | | | | | | |
|---|---|---|---|---|---|---|---|
| Methanol | 10 | parts | 10 | parts | — | 50 | parts |

| | | | | | | |
|---|---|---|---|---|---|---|
| Water | 3 | parts | 3 | parts | — | — |
| 1N SBC | 2 | parts | 2 | parts | — | — |

| | | | | |
|---|---|---|---|---|
| Reaction | acid value: | acid value: | — | acid value: |
| end point | 40.0 mgKOH/g | 20.0 mgKOH/g | | 2.0 mgKOH/g |
| | or less | or less | | or less |
| | FAME content: | FAME content: | | FAME content: |
| | 50.0% or less | 60.0% or less | | 40.0% or less |

### Example 5

20 g of diatomite was added to 1000 g of raw oil (FFA: about 74.3%, tri-glyceride: about 25.7%) having an acid value of about 148.6 mgKOH/g, and then reacted at about 70° C. for about 1 hour to obtain biodiesel raw oil. The obtained biodiesel raw oil includes about 0.6 wt % of particles having a diameter of 1 μm or less.

The biodiesel raw oil was reacted according to the reaction order shown in the application 2 of FIG. 2 under the reaction condition given in Table 6 below. A CSTR was provided with an enzyme catalyst (TRANSZYME™ manufactured by TRASBIODIESEL Corporation in Israel) in which plastic is supported with lipase, a solid acid catalyst guard bed for removing cations was provided with a cation exchange resin (K2629™ manufactured by LANXESS Corporation in Germany), and a solid acid catalyst main bed for an esterification reaction was provided with a polymer resin (GF-101™ manufactured by LANXESS Corporation in Germany) supported with SO₃H⁺.

In this Example, about 15 parts by weight of glycerin, which is a by-product of an enzyme catalyst reaction in CSTR 1, water and the like were removed from the pretreated raw oil, and then this raw oil was supplied to CSTR 2. Then, about 15 parts by weight of glycerin, which is a by-product of an enzyme catalyst reaction in CSTR 2, water and the like were removed from the pretreated raw oil. This raw oil was mixed with the pretreated raw oil having an acid value of 20 mgKOH/g or less at a ratio of 1:1 (wt %), dewatered, and then supplied to a solid acid catalyst guard bed 1. The raw oil having passed through the solid acid catalyst guard bed 1 was mixed with methanol, and the mixture was reacted in the solid acid catalyst main bed 1. The reaction product in the solid acid catalyst main bed 1 was dewatered to remove water and methanol therefrom, further mixed with methanol in the sold acid catalyst main bed 2 and then reacted, thus obtaining raw oil having an acid value of 2.04 mgKOH/g.

TABLE 6

| | Raw oil (acid value: 148.6 mgKOH/g) | | | | | | | | | |
|---|---|---|---|---|---|---|---|---|---|---|
| | Enzyme | | Enzyme | | Solid acid | | Solid acid | | Solid acid | |
| | catalyst | | catalyst | | catalyst | | catalyst | | catalyst | |
| Class. | CSTR 1 | | CSTR 2 | | guard bed | | main bed 1 | | main bed 2 | |
| Reaction | 30° | C. | 30° | C. | about 30° | C. | about 80° | C. | about 80° | C. |
| temperature | | | | | | | | | | |
| Raw oil | 100 | parts | 100 | parts | 100 | parts | 100 | parts | 100 | parts |
| Catalyst | 50 | parts | 50 | parts | 50 | parts | 50 | parts | 50 | parts |

| | | | | | | | | | |
|---|---|---|---|---|---|---|---|---|---|
| Methanol | 10 | parts | 10 | parts | — | 50 | parts | 50 | parts |

| | | | | | | | |
|---|---|---|---|---|---|---|---|
| Water | 3 | parts | 3 | parts | — | — | — |
| 1N SBC | 2 | parts | 2 | parts | — | — | — |

| | | | | | |
|---|---|---|---|---|---|
| Reaction | acid value: | acid value: | — | acid value: | acid value: |
| end point | 40.0 mgKOH/g | 20.0 mgKOH/g | | 10.0 mgKOH/g | 2.0 mgKOH/g |
| | or less | or less | | or less | or less |
| | FAME content: | FAME content: | | FAME content: | FAME content: |
| | 50.0% or less | 60.0% or less | | 40.0% or less | 40.0% or less |

### Example 6

The raw oil (FFA: about 1.0%, tri-glyceride: about 60%, FAME: about 39%) having an acid value of about 1.73 mgKOH/g, obtained in Example 4, was reacted under the reaction condition given in Table 7 below. The sodium methoxide catalyst used in an alkali catalyst reaction was NM25™ (manufactured by EVONIK Corporation in Germany). 100 parts by weight of the raw oil was uniformly mixed with 2.0 parts by weight of sodium methoxide (NaOCH₃) and then reacted at about 70° C. for about 0.5 hour to obtain biodiesel and glycerin. The yield of biodiesel to raw oil was about 98 parts by weight, and the yield of glycerin to raw oil was about 6 parts by weight. The obtained biodiesel has an acid value of 0.16 mgKOH/g and contains 97.8% or more of FAME.

TABLE 7

| | Raw oil (acid value: 99.5 mgKOH/g) | | | | | | | | | |
|---|---|---|---|---|---|---|---|---|---|---|
| | Enzyme | | Enzyme | | Solid acid | | Solid acid | | | |
| | catalyst | | catalyst | | catalyst | | catalyst | | Alkali | |
| Class. | CSTR 1 | | CSTR 2 | | guard bed | | main bed 1 | | catalyst | |
| Reaction | 30° | C. | 30° | C. | about 30° | C. | about 80° | C. | about 70° | C. |
| temperature | | | | | | | | | | |
| Raw oil | 100 | parts | 100 | parts | 100 | parts | 100 | parts | 100 | parts |
| Catalyst | 50 | parts | 50 | parts | 50 | parts | 50 | parts | 2.0 | parts |

| | | | | | | | | |
|---|---|---|---|---|---|---|---|---|
| Methanol | 10 | parts | 10 | parts | — | 50 | parts | — |

| | | | | | | | |
|---|---|---|---|---|---|---|---|
| Water | 3 | parts | 3 | parts | — | — | — |
| 1N SBC | 2 | parts | 2 | parts | — | — | — |

| | | | | | |
|---|---|---|---|---|---|
| Reaction | acid value: | acid value: | — | acid value: | acid value: |
| end point | 40.0 mgKOH/g | 20.0 mgKOH/g | | 2.0 mgKOH/g | 0.5 mgKOH/g |
| | or less | or less | | or less | or less |
| | FAME content: | FAME content: | | FAME content: | FAME content: |
| | 50.0% or less | 60.0% or less | | 40.0% or less | 96.5% or more |

### Example 7

The raw oil (FFA: about 1.0%, tri-glyceride: about 60%, FAME: about 39%) having an acid value of about 2.04 mgKOH/g, obtained in Example 5, was reacted under the reaction condition given in Table 8 below. The potassium methoxide catalyst used in an alkali catalyst reaction was KM32™ (manufactured by EVONIK Corporation in Germany). 100 parts by weight of the raw oil was uniformly mixed with 1.5 parts by weight of potassium methoxide (KOCH₃) and then reacted at about 70° C. for 30 minutes to obtain biodiesel and glycerin. The yield of biodiesel to raw oil was about 98 parts by weight, and the yield of glycerin to raw oil was about 6 parts by weight. The obtained biodiesel has an acid value of 0.17 mgKOH/g and contains 97.4% or more of FAME.

TABLE 8

| | Raw oil (acid value: 99.5 mgKOH/g) | | | | | | | | | |
|---|---|---|---|---|---|---|---|---|---|---|
| | Enzyme | | Enzyme | | Solid acid | | Solid acid | | | |
| | catalyst | | catalyst | | catalyst | | catalyst | | Alkali | |
| Class. | CSTR 1 | | CSTR 2 | | guard bed | | main bed 1 | | catalyst | |
| Reaction | 30° | C. | 30° | C. | about 30° | C. | about 80° | C. | about 70° | C. |
| temperature | | | | | | | | | | |
| Raw oil | 100 | parts | 100 | parts | 100 | parts | 100 | parts | 100 | parts |
| Catalyst | 50 | parts | 50 | parts | 50 | parts | 50 | parts | 1.5 | parts |

| | | | | | | | | |
|---|---|---|---|---|---|---|---|---|
| Methanol | 10 | parts | 10 | parts | — | 50 | parts | — |

| | | | | | | | |
|---|---|---|---|---|---|---|---|
| Water | 3 | parts | 3 | parts | — | — | — |
| 1N SBC | 2 | parts | 2 | parts | — | — | — |

| | | | | | |
|---|---|---|---|---|---|
| Reaction | acid value: | acid value: | — | acid value: | acid value: |
| end point | 40.0 mgKOH/g | 20.0 mgKOH/g | | 2.0 mgKOH/g | 0.5 mgKOH/g |
| | or less | or less | | or less | or less |
| | FAME content: | FAME content: | | FAME content: | FAME content: |
| | 50.0% or less | 60.0% or less | | 40.0% or less | 96.5% or more |

1. A method of preparing biodiesel, comprising the steps of:
removing foreign materials from biodiesel raw oil containing lower fatty acid and having an acid value of 20 mgKOH/g or less with an adsorbent;
dewatering the foreign materials removed biodiesel raw oil;
passing the dewatered biodiesel raw oil through a solid acid catalyst reaction guard bed provided with a cation exchange resin for removing metal cations at 20-80° C. at a flow rate of 6 vol % (6 SV) or less, mixing methanol with the passed biodiesel raw oil, and then passing the mixture through a solid acid catalyst reaction main bed provided with a solid acid catalyst for an esterification reaction at 70-120° C. at a flow rate of 0.5-1.5 SV to adjust a final acid value of the biodiesel raw oil to 5 mgKOH/g or less; and
reacting the biodiesel raw oil having the final acid value of 5 mgKOH/g or less in the presence of an alkali catalyst.

2. A method of preparing biodiesel, comprising the steps of:
removing foreign materials from biodiesel raw oil containing lower fatty acid and having an acid value of more than 20 mgKOH/g with an adsorbent;
passing the foreign materials removed biodiesel raw oil through a continuous stirred tank reactor (CSTR) provided with an enzyme catalyst for an esterification reaction and a transesterification reaction in the presence of methanol, water and a buffer solution to adjust the acid value of the biodiesel raw oil to 20 mgKOH/g or less and adjust a content of FAME to 60% or less, and then separating glycerin;
dewatering the biodiesel raw oil;
passing the dewatered biodiesel raw oil through a solid acid catalyst reaction guard bed provided with a cation exchange resin for removing metal cations, mixing methanol with the biodiesel raw oil passed through the solid acid catalyst reaction guard bed, and then passing the mixture through a solid acid catalyst reaction main bed provided with a solid acid catalyst for an esterification reaction to adjust a final acid value of the biodiesel raw oil to 5 mgKOH/g or less; and
reacting the biodiesel raw oil having the final acid value of 5 mgKOH/g or less in the presence of an alkali catalyst.

3. The method of claim 1, wherein the biodiesel raw oil having lower fatty acid is at least one selected from the group consisting of lower waste cooking oil, palm acid oil, brown grease, white grease, yellow grease, dark oil, trap grease, and non-purified animal oils and fats.

4. The method of claim 1, wherein the step of removing foreign materials is performed by adding 0.1-5 wt % of an adsorbent at a reaction temperature of 30-150° C. and a reaction time of 15 minutes-3 hours.

5. The method of claim 1, wherein the adsorbent is at least one selected from the group consisting of diatomite, acidic white clay, active white clay, active carbon and magnesium silicate.

6. The method of claim 2, wherein the buffer solution is at least one selected from the group consisting of a sodium bicarbonate solution, a sodium carbonate solution, a sodium phosphate solution, a 3-(N-morpholine)propanesulfonic acid solution, a (2-(N-morpholine)ethanesulfonic acid solution, a piperazine-N,N′-bis(2-ethanesulfonic acid) solution, and a (N-(2-hydroxyethyl)piperazine(2-ethanesulfonic acid) solution, and the buffer solution is added until the pH of the biodiesel raw oil is present in a range of 6-7.9.

7. The method of claim 1, the step of dewatering the biodiesel raw oil is performed until the content of water is 0.1 wt % or less.

8. The method of claim 2, wherein, before the step of dewatering the biodiesel raw oil, the biodiesel raw oil from the enzyme catalyst reaction is mixed with a foreign materials-removed biodiesel raw oil having an acid value of 20 mgKOH/g or less at a weight ratio of 1:1 or more to adjust the content of FAME to 40% or less.

9. The method of claim 2, wherein the enzyme catalyst reaction is performed at a reaction temperature of 20-40° C. using 20-60 parts by weight of a catalyst, 1-20 parts by weight of alcohol, 1-10 parts by weight of water, based on 100 parts by weight of the biodiesel raw oil, and a buffer solution capable of adjusting the pH of the biodiesel raw oil to 6-7.9.

10. The method of claim 2, wherein the dewatered biodiesel raw oil is passed through the solid acid catalyst reaction guard bed at a temperature of 20-80° C. at a flow rate of 6 vol % (6 SV) or less.

11. The method of claim 2, wherein the mixture of the biodiesel raw oil and methanol is passed through the solid acid catalyst reaction main bed at a temperature of 70-120° C. at a flow rate of 0.5-1.5 SV.

12. The method of claim 1, wherein the alkali catalyst is at least one selected from the group consisting of sodium methoxide (NaOCH₃), sodium hydroxide (NaOH), potassium methoxide (KOCH₃), and potassium hydroxide (KOH).

13. The method of claim 1, wherein the step of reacting the biodiesel raw oil in the presence of an alkali catalyst is performed at a reaction temperature of 50-80° C. and a reaction time of 10 minutes-2 hours.

14. The method of claim 2, wherein the biodiesel raw oil having lower fatty acid is at least one selected from the group consisting of lower waste cooking oil, palm acid oil, brown grease, white grease, yellow grease, dark oil, trap grease, and non-purified animal oils and fats.

15. The method of claim 2, wherein the step of removing foreign materials is performed by adding 0.1-5 wt % of an adsorbent at a reaction temperature of 30-150° C. and a reaction time of 15 minutes-3 hours.

16. The method of claim 2, wherein the adsorbent is at least one selected from the group consisting of diatomite, acidic white clay, active white clay, active carbon and magnesium silicate.

17. The method of claim 2, the step of dewatering the biodiesel raw oil is performed until the content of water is 0.1 wt % or less.

18. The method of claim 2, wherein the alkali catalyst is at least one selected from the group consisting of sodium methoxide (NaOCH₃), sodium hydroxide (NaOH), potassium methoxide (KOCH₃), and potassium hydroxide (KOH).

19. The method of claim 2, wherein the step of reacting the biodiesel raw oil in the presence of an alkali catalyst is performed at a reaction temperature of 50-80° C. and a reaction time of 10 minutes-2 hours.
